(19) United States
(12) Patent Application Publication
(10) Pub. No.: US 2003/0061273 A1
(43) Pub. Date: Mar. 27, 2003

(54) Extended content storage method and apparatus

(75) Inventor: Matthew A. Hayduk, Calgary (CA)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 09/961,626

(22) Filed: Sep. 24, 2001

(51) Int. Cl. G06F 15/16

(52) U.S. Cl. 709/203

(57) ABSTRACT

An extended content storage system, apparatus, and method are disclosed. The system includes a client and server capable of being communicatively coupled to a communications medium, and a module to monitor the type of content type and its transmission rate as it is stored in a limited local memory maintained by the client. The method includes monitoring the local content storage memory as it is used to acquire the content, and establishing a connection between the client and server to enable sending a selected portion of the acquired content to the server. The method enables subsequent portions of the content to be acquired without exceeding the local memory storage limit, and review of the acquired content during acquisition of subsequent portions.

### BACKGROUND INFORMATION

Mobile computing devices are gaining in popularity due to their increased portability and capability, which includes acquiring and retaining increasingly greater amounts of data pertaining to the individual user. During acquisition, the data is typically stored in a local memory, such as flash memory, or random access memory (RAM), which are both relatively expensive and always limited to that which is physically present in the device. Prior art solutions to increase local storage capability include simply adding more local memory, or physically coupling the mobile device directly to an external storage apparatus, such as a local disk drive. Such solutions are typically expensive, speed limited, and bulky.

Storing multi-media content acquired in real time, such as that generated by multi-megapixel digital video cameras operating at several frames per second, is especially challenging. Thus, even though the number of peripherals and avenues for the generation of local content with regard to a particular mobile computing device are more varied than ever, the amount of such content which can be stored locally by the user is ultimately limited by the size of local memory and/or other local storage devices.

Even when local content can be successfully acquired, the ability to review previously-acquired content during acquisition of subsequent portions may be limited or nonexistent. Reviewing acquired content may be prevented by the speed of the processor within the computing device, or the inability of the mobile device to retain both initial and subsequent portions of the content. Further, review of the content may be abandoned by the user simply because it is determined that only a portion of the content can be acquired (e.g., when local storage is overrun during acquisition). Finally, while mobile computing devices may have the ability to communicate over one or more networks, the speed and capability of the various available networks is typically considered irrelevant with respect to the local storage problem.

Thus, there is a need in the art to provide extended storage capability for mobile computation devices, such as client elements, such that local content may be acquired and stored in a relatively unlimited fashion. In addition, there is a continuing need to provide an extended content storage that has the ability to review acquired content while subsequent acquisition and storage occur, to ensure the quality and verify the substance of what has been acquired.

### BRIEF DESCRIPTION OF THE DRAWINGS

FIG. 1 is a schematic block diagram of an extended content storage system, including a client element, according to an embodiment of the present invention; and

FIG. 2 is a flow chart illustrating a method of extending storage for content according to an embodiment of the present invention.

### DESCRIPTION OF THE PREFERRED EMBODIMENTS

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural, logical, and electrical circuit substitutions and changes may be made without departing from the scope of the invention. The following detailed description, therefore, is not to be taken in a limiting sense, and the scope of the invention is defined only by the appended claims, along with the full range of equivalents to which such claims are entitled.

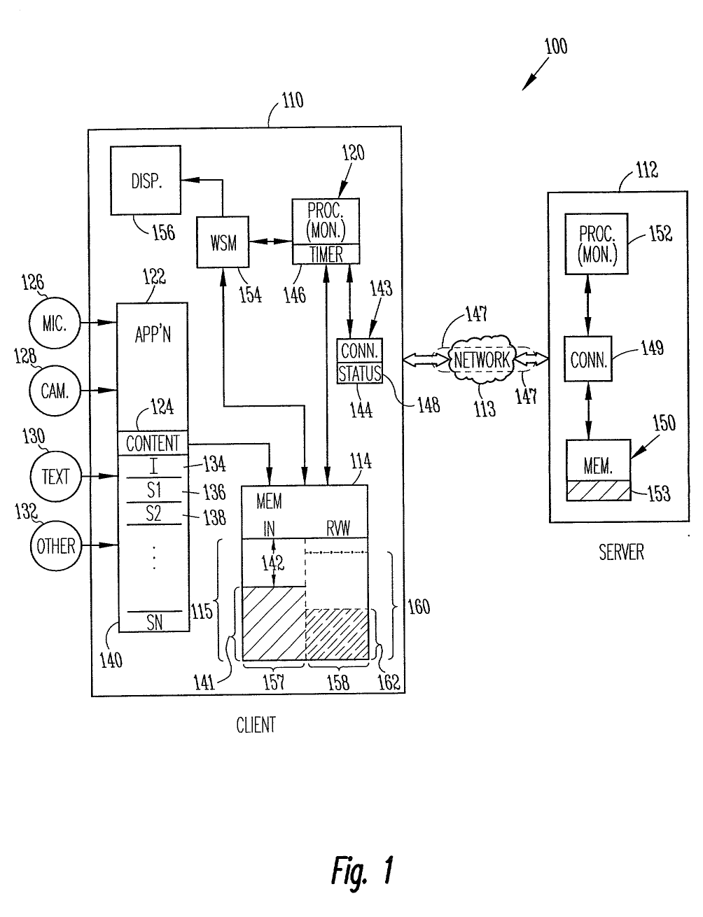

FIG. 1 is a schematic block diagram of an extended content storage system, including a client element, according to an embodiment of the present invention. The system 100 includes a client element 110 communicatively coupled to a server element 112 by way of a communications medium 113, such as a network, including a global telecommunications network, and/or a wireless network. The client element 110, which may be a cellular telephone, a wireless personal digital assistant (PDA), a personal internet client, a two-way pager, or some other mobile two-way communications device, typically includes a memory, which may be an embedded memory 114 with a storage limit 115. The memory 114 is communicatively coupled to a monitoring module 120, which may take the form of a processor coupled to a memory and software (not shown).

The client element 110 typically includes an application 122 which operates to acquire content 124 from various peripherals or sources of data, such as, for example, a microphone 126, a camera 128, a text input device 130, and/or some other device 132, including a high-speed data storage device, such as, for example, an external memory, a serial port, a disk drive, or a data acquisition system. The content 124 may be divided into an initial portion I 134, and one or more subsequent portions S1 136, S2 138, . . . , SN 140.

During execution of the application 122, the initial portion 134 of the content 124 is acquired and stored in the local memory 114. As the initial portion 134 is acquired, the memory 114 begins to fill up with the stored content 141, such that the remaining memory tends toward zero (as the storage limit 115 is reached). For example, if the size of the memory 114 is 16 Mbytes and the storage limit 115 is 8 Mbytes, the amount of remaining memory 142 will be 2 Mbytes if there is 6 Mbytes of stored content 141. Assuming that the size of the initial portion 134 is selected to be 7 Mbytes, and that the total amount of content is 24 Mbytes (i.e., I+S1+S2+ . . . +SN), some type of additional activity should occur to allow additional content 124 to be stored.

In this case the monitoring element 120 typically monitors the amount of remaining memory 142, along with the type and transmission rate of the content 124. These characteristics of the content 124 may be communicated to the module 120 prior to, or during, storage of the initial portion 134, or the module 120 may operate to determine these and other characteristics of the content 124 as acquisition and storage of the content proceeds. The “characteristics” of the content 124 may be defined to be any descriptive parameter of the content 124 which can be numerically quantified, such as the rate of acquisition, the total size of the content in bytes, the expected, forecast, or actual statistical variation in the acquisition rate, the type of content, such as MP3-coded audio, or MPEG-coded video, etc.) To this end, a timer 146 may be coupled to the module 120 to assist with the determination of how rapidly the content 124 is being acquired, and when the storage limit 115 will be reached.

Prior to exceeding the storage limit 141, perhaps considering the amount of remaining memory 142 and the rate of acquisition, a connection module 143 within the client element 110 communicatively coupled to the monitoring module 120 may operate to establish an active communications connection 147 between the client element 110 and the server element 112. The type of connection 147, such as a Bluetooth™ connection, a cellular network connection, or a modem connection to the Internet may be determined according to several factors, including the cost of the connection, the rate of content acquisition, the amount of content to be acquired, privileges available to the user of the client element, and/or the location of the client element in relation to the server element, among others. Thus, connection 147 may also be associated with a status 148, such as connected, maintained, or disconnected.

The server element 112 typically includes a connection module 149 communicatively coupled to a memory 150 and a monitoring module 152 (typically in the form of a processor executing one or more applications). After the connection 147 is established, some or all of the initial portion 134 of the content 124 may be delivered to the server element 112 and stored in the server memory 150. As this occurs, subsequent portions 136, 138, . . . , 140 may also be acquired and stored in the memory 114 of the client element 110. The connection 147 may be terminated and re-established as needed to move subsequent portions 136, 138, . . . , 140 to the server element 112 for storage in the memory 150. In this way, the local memory 114 of the client element 110 will likely not be overrun, and a virtually unlimited amount of content 124 storage may be accommodated via the network 113 and the server element memory 150. In fact, over the period of time needed to acquire all of the content 124, multiple connections 147 may be established, disconnected, and re-established in order to accommodate even greater rates of content storage, and the status 148 of each connection 147 may be monitored by the connection module 143. This process also saves air-link bandwidth since a single connection 147 is not necessarily dedicated to the client element 110 for the entire term of the content acquisition session.

The system 100 and client element 110 may also provide the capability of reviewing the acquired content 141, 153 after at least some of the initial portion 134 of the content 124 has been acquired. This may be accomplished using a windowed service module (WSM) 154 included in the client element 110, typically coupled to the monitoring module 120. Thus, as the initial portion 134 of the content 124 is acquired, the WSM 154 may divide or allocate the memory 114 into an input memory 157 and a review memory 158. A portion of the content stored in the input memory may be copied to the review memory for use by the WSM 154 to show the content on a display 156. Alternatively, the memory 114 may be of the multi-port type, e.g., a dual-port RAM, such that the monitoring module 120 may extract data for transmission to the server element 112 from one memory 114 port at the same time that data is sent from another memory 114 port to the WSM 154 on the way to the display 156. Finally, portions 153 of the content 124 that have already been stored in the memory of the server element memory 150 may be sent over one or more network connections 147 for storage in the review memory 158. The content 162 of the review memory 158 may likewise be monitored by the monitoring module 120 to verify that the review content 162 has not exceeded the new storage limit 160, similar to or identical to the manner in which media is currently streamed to desktop computers for real time display, as is well-known to those skilled in the art. Monitoring of the acquisition process may thus be accomplished using only the monitoring module 120 in the client element 110, or as a combined effort conducted between one monitoring module 120 located in the client element 110, and another monitoring module 152 located in the server element 112, communicating with each other over the network 113.

The WSM 154 may process the content 124 to be shown on the display 156 (or sent to speakers and/or other peripherals, not shown in the drawing) as raw data (e.g., binary or hexadecimal). Alternatively, the WSM 154 may be apprised of the content type (e.g., MP3-encoded audio, MPEG-encoded video, etc.) and display the content 124 after decoding the raw data according to the content type coding standard.

Thus, the invention also includes a client element 110 which has a monitoring module 120, a local memory 114 communicatively coupled to the monitoring module 120, and a communications medium interface 148, which may be a wireless communications medium interface including a connection module 143, communicatively coupled to the local memory 114. As noted above, the local memory is typically associated with a selected storage limit 115. The client element 110 may also include a WSM 154 coupled to the monitoring module 120. One or more data acquisition elements, such as a microphone 126, a camera 128, a text input device 130, and/or some other device 132, including a high-speed data storage device, such as an external memory, a disk drive, a wireless receiver, a modem, a wireline receiver, a communications port, an analog-to-digital conversion device, or even an entire data acquisition system may be communicatively coupled to the local memory 114.

It should be noted that the monitoring module 120, application 122, connection module 143, timer 146, connection module 149, monitoring module 152, and WSM 154 may all be characterized as “modules” herein. Such “modules” may include hardware circuitry, such as a microprocessor and memory, software program modules, or firmware, and combinations thereof, as desired by the architect of the system 100, and appropriate for particular implementations of the invention. Further, while the monitoring module 120 of the invention may comprise a single module 120 coupled to the client element 110, residing within or without the client element, the monitoring module 120 may also operate as a monitoring module 120 which shares the duty of monitoring the transmission and storage of the content 124 by communicating with another monitoring module 152, coupled to the server element 112, and residing within or without the server element 112.

One of ordinary skill in the art will understand that system and apparatus of the present invention may be used other applications, and thus, the invention is not to be so limited. The illustrations of a system 100, a client element 110, and a server element 112 are intended to provide a general understanding of the structure of the present invention, and are not intended to serve as a complete description of all the elements and features of extended content storage systems, client elements, and server elements which might make use of the structures described herein.

Applications which may include the novel extended content storage system, client element, and server element of the present invention include electronic circuitry used in high-speed computers, communications ports and other equipment, modems, processor modules, embedded processors, and application-specific modules, including multilayer, multi-chip modules. Such systems, clients, and servers may further be included as sub-components within a variety of electronic systems, such as televisions, cellular telephones, personal computers, personal radios, automobiles, aircraft, and others.

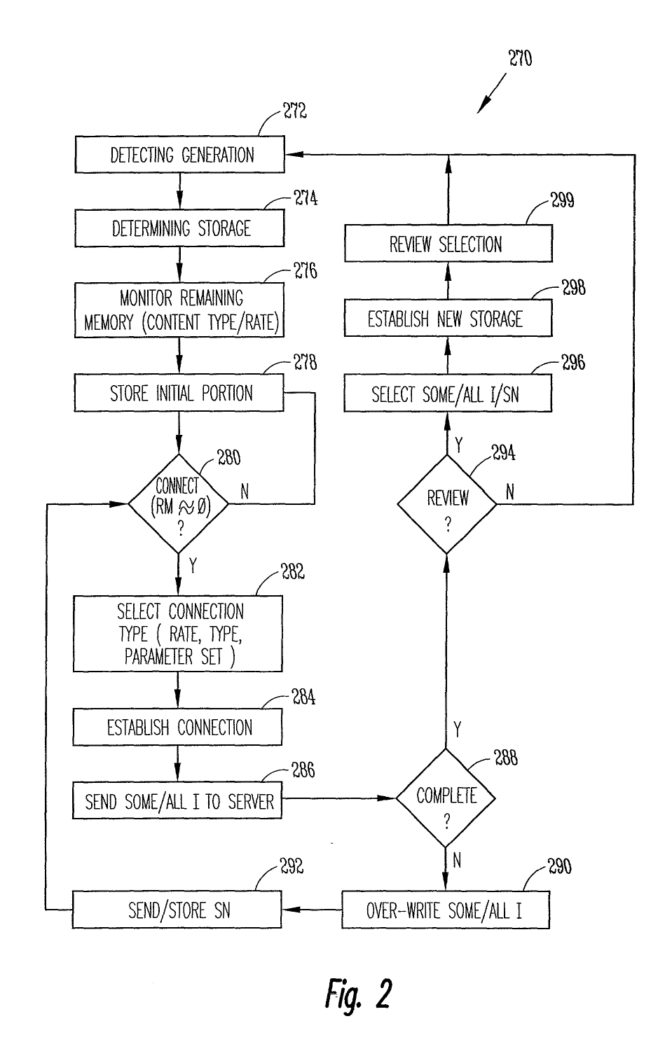

FIG. 2 is a flow chart illustrating a method of extending storage for content according to the present invention. The method may begin with detecting generation of the content at block 272, determining that the content is to be stored in the local memory associated with a selected storage limit at block 274, and then monitoring the remaining amount of memory corresponding to the storage limit at block 276. This process may include monitoring the type of content to be acquired and stored, and the rate at which the content is generated/stored.

At this point, some or all of the initial portion of the content may be stored in the local memory (block 278). Storage of the initial portion continues until it is determined that the remaining amount of memory is approaching zero, or is approximately equal to zero (block 280) (i.e., given the rate of data transmission and other relevant factors, it is determined that the time required to establish a connection would cause the storage limit to be exceeded, and/or any remaining local memory to be overrun). In other words, block 280 refers to determining that the remaining amount of memory will be approximately equal to zero within a calculated time period associated with a connection to be established between the client element and a server element. When this occurs, a connection type associated with a connection to be established with a server may be selected at block 282, based on the rate of acquisition and/or storage, the content type and/or its characteristics, and/or a set of parameters associated with the network 113 or the system 100. Such parameters might include the location of the server element, the location of the client element, the cost of the connection, the selected storage limit, and other factors which may have been determined by the client, the server, or some other network element or peripheral connected to the client. The process of establishing a connection between the client and server elements may also take into account the length of time required to establish a connection, as this may be highly variable depending on the nature of the physical devices used to effect the connection (e.g. telephone modem, dedicated T1 line, etc.). Whether a connection will be established at all may also be determined at block 280, by monitoring the connection setup time, content transmission rate, the time required to begin transferring the content to the server, and the amount of local memory remaining.

Once the connection type is selected in block 282, one or more connections may be established between the client element and the server element at block 284. A selected part of the initial portion of the content may then be sent to the server element from the client element using the established connection at block 286, and transport of the content across the network connection(s) continues until the monitoring element in the client (or cooperating monitoring elements in the client and server, respectively) determine that all of the content which is to be passed from the client element to the server element during a particular session has been sent to the server for storage in its memory. Some or all of the initial portion may be made available for over-write (or even deleted from the local memory of the client) at block 290 to accommodate acquisition and storage of subsequent portions in the local memory so that these subsequent portions, in turn, can be sent to the server element for storage at block 292. The process continues as the amount of remaining local memory is continually monitored by the client element monitoring module, and connections are established, disconnected, and re-established as more of the content is sent to the server (blocks 280 . . . 286). Data transfer between the client and server elements may also be optimized to support any wireless technology which is used to effect the connection, such as circuit switched, short message service, packet data, etc.).

As mentioned previously, and depending on the rate of content acquisition and/or storage, one or more network connections between the client and server elements may be established, disconnected, and re-established, as needed. A connection module in the client (or cooperating connections modules in the client and server elements, respectively) may monitor the status of the connections(s) during the process, denoted above as: connected, maintained, or disconnected.

At some point during the content acquisition and storage process, or after its completion, the method of the invention may include using a WSM residing on the client element to review some or all of the content. Thus, the method may include selecting some portion of the content (e.g., some or all of the initial portion, or one of the subsequent portions) for review at block 296, establishing a new storage limit associated with the local review memory which is generally less than the previously selected storage limit (for the input memory) at block 298, and then reviewing the selected part of the initial or subsequent portion of the content at the client element using the WSM at block 299. The method 270 may end at this point, or continue with the generation and acquisition of other content at block 272.

The apparatus and method of the invention provides a seamless storage mechanism as perceived by the client user. Thus, the local memory is no longer considered to be the absolute storage limit for locally-generated content. Local content can thus be acquired and stored in a relatively unlimited fashion. The extended content storage of the present invention also provides the ability to review acquired content while subsequent storage takes place, enabling verification of the quality and substance of that which has been acquired. Securing these advantages does not require procuring additional expensive hardware, or attaching bulky physical objects to the client element.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures and methods are used. The scope of the invention should be determined with reference to the appended claims, along with the full range of equivalents to which such claims are entitled.

What is claimed is:

1. An extended content storage system, comprising:
a monitoring module;
a client element including a local memory communicatively coupled to the monitoring module, and an application to receive an initial portion of the content and a subsequent portion of the content, the local memory being associated with a selected storage limit approximately less than or equal to the initial portion of the content; and
a server element capable of being communicatively coupled to the client element and having a server memory to store the initial and the subsequent portions of the content.

2. The extended content storage system of claim 1, further comprising:
a communications medium capable of being communicatively coupled to the client element and the server element.

3. The extended content storage system of claim 1, wherein the monitoring module monitors a content type and a transmission rate associated with the content, and an amount of remaining memory associated with the selected storage limit.

4. The extended content storage system of claim 1, further comprising:
a connection module communicatively coupled to the monitoring module.

5. The extended content storage system of claim 1, wherein a status of the communications medium is selected from a group consisting of: connected, maintained, and disconnected.

6. The extended content storage system of claim 1, wherein the client element includes a windowed service module coupled to the local memory for review of the initial and subsequent portions of the content.

7. The extended content storage system of claim 6, wherein the windowed service module is coupled to a display.

8. The extended content storage system of claim 1, wherein the monitoring module is a first monitoring module residing within the client element communicating with a second monitoring module residing within the server element.

9. The extended content storage system of claim 1, wherein the communications medium includes a wireless network.

10. The extended content storage system of claim 1, wherein the monitoring module is coupled to a timer.

11. A client element for extended storage of content, comprising:
a monitoring module; and
a local memory communicatively coupled to the monitoring module and capable of storing an initial portion of the content and a subsequent portion of the content, the local memory being associated with a selected storage limit monitored by the monitoring module and which is approximately less than or equal to the initial portion of the content.

12. The client element of claim 11, further comprising:
a wireless communications medium interface communicatively coupled to the local memory and capable of being communicatively coupled to a server element for storing the initial portion of the content on the server element.

13. The client element of claim 11, further comprising:
a windowed service module coupled to the local memory.

14. The client element of claim 11, further comprising:
a data acquisition element communicatively coupled to the local memory.

15. The client element of claim 11, wherein the data acquisition element is selected from the group consisting of: a text input device, a wireless receiver, a communications port, a modem, a wireline receiver, an analog-to-digital conversion device, a storage device, a camera, and a microphone.

16. A method of extending storage for content, comprising:
monitoring a remaining amount of memory associated with a selected storage limit in a local memory;
storing an initial portion of the content in the local memory;
determining that the remaining amount of memory will be approximately equal to zero within a calculated time period associated with a connection to be established between a client element and a server element;
establishing the connection between the client element including the local memory and the server element including a server memory; and
sending a selected part of the initial portion of the content to the server element from the client element using the connection.

17. The method of claim 16, further including:
determining that the content is to be stored in the local memory.

18. The method of claim 16, further including:
storing a subsequent portion of the content in the local memory.

19. The method of claim 16, further including:
detecting generation of the content.

20. The method of claim 16, further including:
monitoring a content type and data transmission rate associated with the content.

21. The method of claim 20, wherein a connection type associated with the connection is determined in accordance with the content type and data transmission rate.

22. The method of claim 16, further including:
deleting the selected part of the initial portion from the local memory.

23. The method of claim 16, wherein establishing a connection between a client element including the local memory and a server element further includes:
selecting a connection type associated with the connection according to a set of parameters.

24. The method of claim 23, wherein the set of parameters may include a location of the server element, a location of the client element, a cost of the connection, the selected storage limit, and a content type and data transmission rate associated with the content.

25. The method of claim 16, further including:
reviewing a selected part of the content at the client element using a windowed service module included in the client element.

26. The method of claim 25, further including:
establishing a new selected storage limit associated with the local memory which is less than the selected storage limit.

27. The method of claim 16, further including:
dividing the local memory into an input memory and a review memory.

28. The method of claim 16, further including:
reviewing a selected part of the subsequent portion of the content at the client element using a windowed service module residing at the client element.
